(19) United States
(12) Patent Application Publication
(10) Pub. No.: US 2016/0081510 A1
(43) Pub. Date: Mar. 24, 2016

(54) COOKING METHOD AND COOKING DEVICE

(71) Applicant: RATIONAL AKTIENGESELLSCHAFT, Landsberg am Lech (DE)

(72) Inventors: Michael FINK, Wessling (DE); Gerd FUNK, Bickenbach (DE)

(21) Appl. No.: 14/893,426

(22) PCT Filed: May 16, 2014
(86) PCT No.: PCT/EP14/60129

§ 371 Date: Nov. 23, 2015

(30) Foreign Application Priority Data
May 23, 2013 (FR) 1354641

(51) Int. Cl. A47J 27/16; G05B 15/02; A23L 1/01

(52) U.S. Cl. CPC A47J 27/16; A23L 1/0128; G05B 15/02; A23V 2002/00

(57) ABSTRACT

In a method of cooking food in a cooking device, an operator is able to select a specific cooking process from a multitude of predefined automated cooking processes and/or manually select parameters for a manual cooking process, at least one significant cooking process parameter being continuously logged in a memory by a control unit of the cooking device from the start of the cooking process, and it being possible for the operator to change from a manual cooking process to an automated cooking process, and vice versa. Also provided is a cooking device for cooking food, having a control unit including a memory for at least one significant cooking process parameter, and the operating unit offering a changeover switch by which the operator can change from an automated cooking process to a manual cooking process, and vice versa.

The invention relates to a method of cooking food in a cooking device, an operator being able to select a specific cooking process from a multitude of predefined automated cooking processes and/or manually select parameters for a manual cooking process. The invention further relates to a cooking device for cooking food, including a control unit in which a multitude of predefined automated cooking processes are stored, and an operating panel by means of which an operator can select one of the automated cooking processes and/or can manually input parameters for a manual cooking process.

Cooking devices of this type are known in particular from the catering sector (restaurant and company canteen kitchens and large-scale catering businesses). They may be configured as so-called combination steamers, that is, cooking devices in which the food to be cooked is cooked with hot air and/or steam.

To relieve the operator, different automated cooking processes are stored in the cooking device, by which different types of food can be cooked in a reproducible manner to give them a desired state. In an automated cooking process, at least the desired final state of the food to be cooked is stored in the control unit. That is, automated cooking processes work in a result-oriented manner. The control unit selects the appropriate cooking process parameters and/or, before or during the cooking procedure, adapts them to the state or the properties of the food to be cooked, such as, e.g., the size, weight or degree of browning of the food to be cooked, in order to achieve the desired cooking result.

Alternatively to an automated cooking process, an operator may also select a manual cooking process, in which he/she specifies in particular the temperature, cooking chamber atmosphere and cooking time, as based on his/her experience. It is also conceivable that sets of cooking process parameters are stored in the control unit, which can be manually selected by the user. These sets of cooking process parameters, also referred to as cooking programs, may well include a plurality of cooking steps with different parameters. But in contrast to the cooking process parameters of automatic cooking processes, they are not adapted by the control unit to the state or the properties of the food to be cooked, but remain fixed without a manual adjustment of the user. Consequently, manual cooking processes are inflexible. Only the end of the cooking process or of a cooking step can be flexibly determined if it is defined as reaching a specific core temperature of the food to be cooked. The simplest case of a manual cooking process is constituted by the continuous operation of the cooking device at a particular temperature.

The object of the invention consists in providing a method of cooking food and a cooking device which allow an operator to have greater flexibility.

To achieve this object, in a method of the type initially mentioned, provision is made according to the invention that at least one significant cooking process parameter is continuously logged in a memory by a control unit of the cooking device from the start of the cooking process and that it is possible for the operator to change from a manual cooking process to an automated cooking process, and vice versa. In a cooking device of the type initially mentioned, to achieve this object provision is made that the control unit includes a memory for at least one significant cooking process parameter, and that the operating panel offers a changeover switch by which the operator can change from an automated cooking process to a manual cooking process, and vice versa. The invention is based on the fundamental idea of giving an operator greater flexibility by providing him/her with the possibility to switch between automated cooking processes and manual cooking processes as desired. This is possible since, according to the invention, a cooking process parameter that is significant to the currently running cooking process is logged and stored. For example, when the operator starts a manual cooking process, the cooking device, in the background, stores significant cooking process parameters such as the energy input into the food to be cooked. If the operator then switches to an automated cooking process at a later point in time, the cooking device knows, based on the cooking process parameters logged, the state the food to be cooked is in at this particular point in time. Therefore, parameters can then be used that are suitable for the selected automated cooking process, for example the cooking chamber temperature and cooking duration, by which the desired state of the food is reached in an automated manner. Switching between the different cooking processes is also possible the other way round; the operator may start with an automated cooking process and may then intervene by manually influencing specific cooking parameters. In this case, too, it is still possible for the operator to return to an automated cooking process. Basically, switching between the different cooking processes is possible as often as desired.

According to one configuration of the invention, provision is made that the desired properties of the food cooked to completion are queried by the control unit when the operator changes from a manual cooking process, which was started on the basis of manually defined parameters, to an automated cooking process for the first time. This query can be effected explicitly or else indirectly in that the operator, when changing to the automated cooking process, selects a cooking process in which the desired properties of the food cooked to completion are known. Regardless of whether the query is effected explicitly or implicitly, this step ensures that it is known to the control unit of the cooking device which state the cooked food is to have at the end of the automated cooking process.

According to one configuration of the invention, provision may also be made that the desired properties of the food cooked to completion are stored by the control unit when the operator changes from an automated cooking process to a manual cooking process. This ensures that the desired properties of the food cooked to completion are still available “in the background” when the operator switches back again from the manual cooking process to an automated cooking process.

According to a preferred embodiment, provision is made that when there is a change from a manual cooking process to an automated cooking process, the control unit checks, based on the significant cooking process parameters stored in the memory, whether the desired properties of the food cooked to completion can be obtained. The significant cooking process parameters available at the moment of change from the manual cooking process to the automated cooking process allow the control unit to determine the current state of the food being cooked. In a simple example, the core temperature of roast beef can be assumed to be a significant cooking process parameter. If the operator changes to an automated cooking process with “roast beef medium rare” being the desired property at a time when the core temperature of the food is as high as 64° C., the cooking device can no longer bring the food to the desired state.

Preferably, provision is made that a notice is displayed to the operator if the desired properties of the food cooked to completion can not be obtained. This allows the operator to either break off the cooking process or to modify it in such a manner that a result that is acceptable to him/her is reached.

Provision may also be made that a suggestion for alternative properties of the food cooked to completion is made to the operator if the desired properties can not be obtained. In this case, the cooking device selects that property which comes closest to the actually desired result from the multitude of automated cooking processes stored and the associated food properties.

If the operator accepts the suggested alternative properties, these are preferably stored as new desired properties. This makes sure that when there is another change to a manual cooking process and back again to an automated cooking process, desired properties for the food to be cooked are available which are the basis for the cooking process proceeding in an automated fashion again.

Preferably, provision is made that upon a change from an automated cooking process to a manual cooking process, a notice is displayed to the operator if the desired properties of the food cooked to completion can not be obtained with the newly selected parameters. Such a notice makes sense, for example, when the operator changes to a manual cooking process and increases the cooking chamber temperature shortly before a final state, defined by means of the core temperature, for example, is reached in an automated cooking process. With this constellation, it is foreseeable that the core temperature in the interior of the food will quite rapidly reach values above the actually desired range.

The significant cooking process parameter may be, for example, the energy input into the food to be cooked, the profile of the core temperature, the cooking chamber temperature, the fan speed and/or the humidity within the cooking chamber. But basically any parameter having an influence on the properties of the food to be cooked may be logged.

According to a further configuration of the invention, the cooking device includes an energy meter. This allows one of the most meaningful parameters to be logged as the significant cooking process parameter, namely the total energy input into the food to be cooked.

The invention will be described below with reference to various examples and the accompanying drawings, in which:

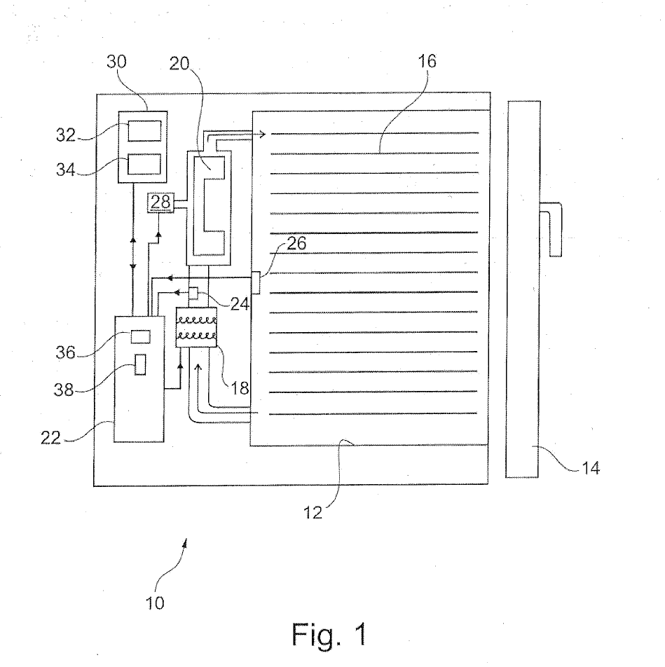

FIG. 1 schematically shows a cooking device according to the invention;

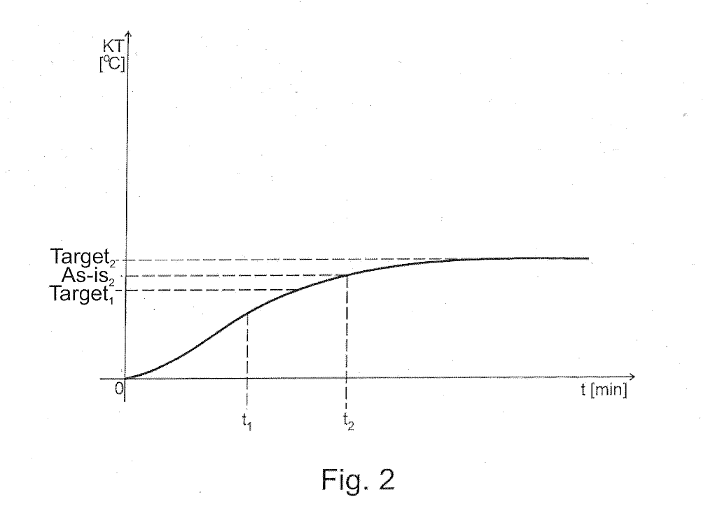

FIG. 2 shows a diagram in which the effect of a manual intervention on the core temperature is explained, which is used as a reference variable of an automated cooking process; and

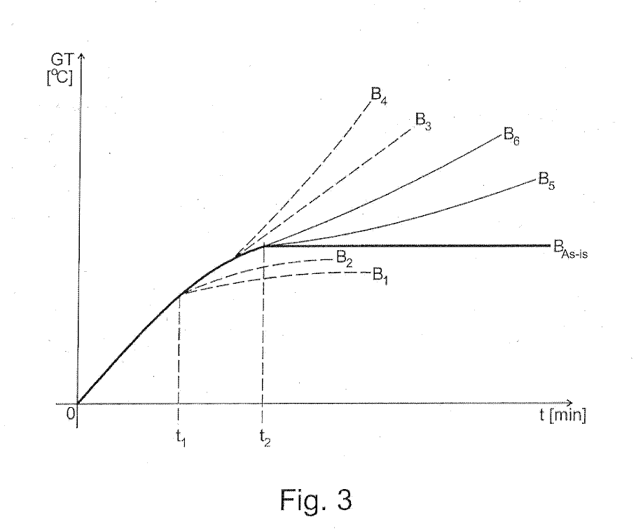

FIG. 3 shows a further diagram in which the effect of a manual intervention on the browning to be achieved by means of an automated cooking process is explained.

FIG. 1 schematically shows a cooking device 10 which is intended for professional use in large-scale catering businesses, in restaurants, canteens etc. It includes a cooking chamber 12 which is accessible from outside by opening a door 14. Cooking accessories 16, which are schematically indicated here, for example baking sheets, grilling plates, baking pans or grates on which products to be cooked are placed, may be arranged in the cooking chamber.

To generate a desired cooking chamber atmosphere, a heating device 18 and a fan wheel 20 are provided by which the atmosphere existing in the cooking chamber 12 can be heated and circulated. A steam module may also be integrated in the heating device 18 here to achieve a certain humidity in the cooking chamber atmosphere.

Further components, such as a ventilation of the cooking chamber 12 to the external atmosphere, a quenching box etc., are not illustrated here for the sake of better clarity.

The cooking device 10 also contains a control unit 22 which, inter alia, receives signals from a temperature sensor 24 that is arranged immediately downstream of the heating device 18 here, as well as from a humidity sensor 26 that is arranged in the interior of the cooking chamber 12 here. The control unit 22 drives the heating device 18 and a driving motor 28 of the fan wheel, among others. Further provided is an operating unit 30 which includes an input window 32 and an output window 34. The input window 32 and the output window 34 may also be combined to form a multifunctional unit. Furthermore, the operating unit 30 may be configured to emit acoustic signals, for example an information tone as an input acknowledgment or a signaling tone when the end of a cooking process is reached.

A multitude of automated cooking processes are stored in the control unit 22, which are associated with different kinds of food to be cooked and different properties which the foods to be cooked are intended to have upon completion of the automated cooking process. These automated cooking processes can be selected by the operator via the input window 32. For one, the automated cooking process selected can then be displayed to the operator in the output window. Furthermore, for example, the remaining cooking time, the cooking chamber temperature or the partial process coming up next (for example, steaming or frying until brown) may be displayed.

The input window 32 also serves to switch between an automated cooking process and a manual cooking process. An automated cooking process here means a cooking process in which an operator fixedly predefines at least one essential parameter, so that the cooking process is no longer controlled by the control unit 22.

Changing from an automated cooking process to a manual cooking process may be effected directly in that the operator specifies certain parameters, such as, e.g., the cooking chamber temperature, in a fixed manner by means of the input device 32. Such an intervention on the part of the, operator can be intuitively interpreted by the control unit such that the operator wishes to discontinue the currently proceeding automated cooking process.

As an alternative, provision may be made for the operator to have the option to discontinue the currently proceeding automated cooking process. In that case, preferably those parameters which are necessary for a cooking process are then actively queried by the control unit 22, in particular the cooking chamber temperature and the humidity within the cooking chamber.

Changing to a manual cooking process may also be effected in the form of a mixture of the two above-mentioned variants, in that upon a manual input of a parameter, the operator is at first requested to confirm the discontinuation of the automated cooking process. When the confirmation has been effected, the operator can subsequently be queried by the control unit via the operating unit 30 to obtain the parameters necessary for the manual cooking process.

It is possible at any point in time to change from a manual cooking process to an automated cooking process. This is also effected via the input window 32; here, the operator can either select an entirely new automated cooking process (in particular in case the current cooking process had been started as a manual cooking process) or can continue an earlier automated cooking process if the latter had been interrupted by the manual input of parameters.

For each change from an automated cooking process to a manual cooking process or vice versa, the input window 32 functions as a changeover switch. But other types of inputting may also be provided for switching from one cooking mode to a different one.

Generally speaking, an essential prerequisite for the possibility of changing from a manual cooking process to an automated cooking process is that the control unit 22 has sufficient information at all times about the current state of the food to be cooked. For this purpose, a memory 36 is provided by means of which at least one significant cooking process parameter is continuously logged by the control unit 22. This cooking process parameter may be the energy input into the food to be cooked, the profile of the core temperature, the cooking chamber temperature, the fan speed and/or the humidity within the cooking chamber. A plurality of these parameters may also be continuously recorded here.

It is possible that the significant cooking process parameters are only logged by the control unit 22 and are evaluated only when required, i.e. when there is a transition from a manual to an automated cooking process, in order to obtain the required information about the state of the food. It is also possible for the control unit 22 to continuously evaluate the cooking process parameters, so that the complete information about the state of the food being cooked is available at all times.

According to one configuration of the invention, the memory 36 may contain an energy meter 38. During a cooking process, the energy meter integrates the specific heat input into the product to be cooked versus the cooking time. In this context, “specific heat input” is the amount of energy absorbed for each unit area of the surface of the product to be cooked, per unit time. Here, the heat transfer coefficient from the cooking chamber atmosphere into the food to be cooked, the driving temperature difference between the temperature in the cooking chamber and the surface temperature of the product to be cooked, and further parameters are taken into account, such as, e.g., the humidity within the cooking chamber. Further details about how the specific heat input is integrated may be gathered from EP 2 469 173 A2, to which reference in its entirety is made.

The significant cooking process parameter logged in the memory 36 is comparable to the current position that is continually recorded in a navigation system of a motor vehicle. Regardless of whether the driver has selected a destination at the start of his/her journey (comparable to the final state of the food to be cooked), the driver can activate a route guidance at any time (that is, start an automated cooking process), whereupon, proceeding seamlessly from the current position (that is, the cooking process parameters logged, such as, for example, the core temperature or the energy input), the route guidance will start (that is, a cooking process with suitable parameters in order to obtain the desired properties of the food to be cooked). In the same way as in a navigation device, the operator of the cooking device can leave the specified route as desired, i.e. can select a manual cooking process in the meantime, specifying particular parameters, and can also return to the specified route again, i.e. activate an automated cooking process again.

By means of a manual intervention, an operator can, for example, influence the browning of a food to be cooked. If the operator realizes that, for example, he/she wishes a roast beef to be fried more heavily on the outside than is the case in the currently used automated cooking process, he/she can select a higher cooking chamber temperature for a short time. This temperature ensures a more intensive browning.

As long as this higher temperature is selected only for a short period of time and the operator switches back again to an automated cooking process relatively quickly, this will not result in any difficulties to speak of. Using its control unit, the cooking device automatically takes the actual energy input into consideration which, because of the higher cooking chamber temperature, is above the energy input as would have resulted for an uninterrupted automated cooking process. Accordingly, either the remaining cooking time can be reduced or a somewhat lower cooking chamber temperature can be selected for the remaining cooking time.

Things become somewhat more complex if the intervention on the part of the operator is so profound that the originally selected properties of the food to be cooked can no longer be maintained. This is the case in particular when, due to the manual intervention of the operator, the energy input into the product to be cooked is so high that an excessive browning or too high a core temperature is reached. When there is a transition back to an automated cooking process again after the manual intervention, this can not be undone. If fish, for example, which is actually intended to be cooked to translucency as a result of the automated cooking process, is already completely cooked until well-done when there is a transition from the manual cooking process to the automated cooking process, it can no longer be served translucent.

One option in such a situation consists in that upon the transition to the automated cooking process, an information is displayed to the operator that the food to be cooked is already sufficiently cooked and should not be cooked any further. Moreover, an information may be displayed to the operator as to which state the food has already reached. In situations in which the manual influence of the operator does not have such serious effects, a suggestion for altered properties of the food to be cooked may be made to the operator when changing to an automated cooking process. This suggestion takes into account the current state of the food to be cooked as well as the information, stored in the control unit, about further cooking process steps (and the associated energy input) which still need to be carried out, for example simmering or a browning phase. An example of such an adaptation will be explained below with reference to FIG. 2.

In FIG. 2, the profile of the core temperature KT versus time is plotted for roast beef as the food to be cooked. The temperature Target₁ is the core temperature preselected by the operator for an automated cooking process, to obtain the “rare” state. At the moment t₁, the operator intervenes manually in order to obtain a more intensive browning of the food: he/she increases the cooking chamber temperature. At the moment t₂, the operator returns to the automated cooking process again. At that point in time, however, the core temperature is already at a temperature As-is₂, which is above the temperature Target₁. It is obvious that the originally desired “rare” state can no longer be obtained. In addition, it is known to the controller of the cooking device that even if the cooking process were to be discontinued immediately at the moment t₂, the core temperature in the roast beef will still increase a little further since because of the amount of heat stored in the meat and the heat conduction, heat continues to migrate to the middle of the roast beef even if the surface is brought to ambient temperature. The control unit will then suggest to the operator a new product state, which is in line with the core temperature Target₂ which is still possible now and which, due to the inevitable continued cooking, is about 3° C. above the temperature As-is₂ upon the transition from the manual to the automated cooking process. The automated cooking process can then be continued in the form of a resting phase at a lower cooking chamber temperature.

FIG. 3 illustrates a diagram in which the influence of the cooking chamber temperature on browning is explained. For the sake of simplicity, it is assumed here that a higher cooking chamber temperature will result in a correspondingly increased browning; for simplification, in this diagram the cooking chamber temperature may be understood as a synonym for the browning.

When a cooking process starts at the moment 0, the operator can select from a multitude of different degrees of browning of a roast beef, for example, which is in the cooking chamber. These different degrees of browning are referred to as B₁ to B₄ here.

If a manual intervention takes place at the moment t₁, which lasts until the moment t₂, at this point in time a browning B_{As-is} has been reached which is above the two degrees of browning B₁ and B₂. If the operator switches back to an automated cooking process at this point in time, the degrees of browning B₁ and B₂ will not be offered to him/her as possible target parameters any more. As alternatives, he/she will be offered the degrees of browning B_{As-is}, B₅ and B₆, for example.

While for the purpose of better clarity, the diagrams of FIGS. 2 and 3 show a cooking process which begins in an automated fashion and is interrupted only once by a manual intervention, an automated cooking process can also be interrupted manually several times and then be resumed again. It is also possible for the operator to start a cooking process manually and to switch to an automated cooking process at any desired point in time. This may happen, for example, in a case in which the operator had actually intended to cook completely manually, but is required to turn his/her attention to a different activity at a certain point in time. In this case, he/she can hand over the cooking process to the control unit of the cooking device, which then realizes the properties selected by the operator for the food to be cooked.

1. A method of cooking food in a cooking device, wherein an operator is able to select a specific cooking process from a multitude of predefined automated cooking processes and/or manually select parameters for a manual cooking process, wherein at least one significant cooking process parameter is continuously logged in a memory by a control unit of the cooking device from the start of the cooking process, and wherein it is possible for the operator to change from a manual cooking process to an automated cooking process, and vice versa.

2. The method according to claim 1, wherein the desired properties of the food cooked to completion are queried by the control unit when the operator changes from a manual cooking process, which was started on the basis of manually defined parameters, to an automated cooking process for the first time.

3. The method according to claim 1, wherein the desired properties of the food cooked to completion are stored by the control unit when the operator changes from an automated cooking process to a manual cooking process.

4. The method according to claim 2, wherein when there is a change from a manual cooking process to an automated cooking process, the control unit checks, based on the significant cooking process parameters stored in the memory, whether the desired properties of the food cooked to completion can be obtained.

5. The method according to claim 4, wherein a notice is displayed to the operator if the desired properties of the food cooked to completion cannot be obtained.

6. The method according to claim 5, wherein a suggestion for alternative properties of the food cooked to completion is made to the operator if the desired properties cannot be obtained.

7. The method according to claim 6, wherein the suggested alternative properties are stored as new desired properties if the operator accepts the suggested alternative properties.

8. The method according to claim 2, wherein upon a change from an automated cooking process to a manual cooking process, a notice is displayed to the operator if the desired properties of the food cooked to completion cannot be obtained with the newly selected parameters.

9. The method according to claim 2, wherein the significant cooking process parameter is selected from the group consisting of an energy input into the food to be cooked, a profile of the core temperature, a cooking chamber temperature, a fan speed and an humidity within the cooking chamber.

10. A cooking device for cooking food, comprising a control unit in which a multitude of predefined automated cooking processes are stored, and an operating unit by which an operator can select one of the automated cooking processes and/or can manually input parameters for a manual cooking process, wherein the control unit includes a memory for at least one significant cooking process parameter, and in that the operating unit offers a changeover switch by which the operator can change from an automated cooking process to a manual cooking process, and vice versa.

11. The cooking device according to claim 10, wherein the cooking device includes an energy meter.

12. The method according to claim 3, wherein when there is a change from a manual cooking process to an automated cooking process, the control unit checks, based on the significant cooking process parameters stored in the memory, whether the desired properties of the food cooked to completion can be obtained.

13. The method according to claim 12, wherein a notice is displayed to the operator if the desired properties of the food cooked to completion cannot be obtained.

14. The method according to claim 13, wherein a suggestion for alternative properties of the food cooked to completion is made to the operator if the desired properties cannot be obtained.

15. The method according to claim 14, wherein the suggested alternative properties are stored as new desired properties if the operator accepts the suggested alternative properties.

16. The method according to claim 15, wherein upon a change from an automated cooking process to a manual cooking process, a notice is displayed to the operator if the desired properties of the food cooked to completion cannot be obtained with the newly selected parameters.

17. The method according to claim 16, wherein the significant cooking process parameter is selected from the group consisting of an energy input into the food to be cooked, a profile of the core temperature, a cooking chamber temperature, a fan speed and an humidity within the cooking chamber.
